(19) United States
(12) Patent Application Publication
(10) Pub. No.: US 2011/0012936 A1
(43) Pub. Date: Jan. 20, 2011

(54) BACKLIGHT ASSEMBLY AND DISPLAY APPARATUS HAVING THE SAME

(75) Inventor: Tae-sung Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/831,681

(22) Filed: Jul. 7, 2010

(30) Foreign Application Priority Data
Jul. 17, 2009 (KR) 10-2009-0065329

(51) Int. Cl. G09G 5/10; H05B 37/02

(52) U.S. Cl. 345/690; 315/347; 315/210; 345/102

(57) ABSTRACT

Provided is a backlight assembly and a display apparatus having the same, the backlight assembly including: a power converter which includes a transformer and converts a level of input power; a power factor corrector which corrects a power factor of original power and outputs it to the power converter; and a light source driver which is connected to a secondary coil of the transformer and includes a first light emitting diode module, a second light emitting diode module, and a current supplying circuit which balances amperage of power supplied to the first light emitting diode module and the second light emitting diode module.

### CROSS-REFERENCE TO RELATED APPLICATION

This application claims priority from Korean Patent Application No. 10-2009-0065329, filed on Jul. 17, 2009 in the Korean Intellectual Property Office, the disclosure of which is incorporated herein by reference in its entirety.

### BACKGROUND

1. Field

Apparatuses and methods consistent with the exemplary embodiments relate to a backlight assembly and a display apparatus having the same, and more particularly, to a backlight assembly with a light emitting diode (LED) and a display apparatus having the same.

2. Description of the Related Art

As an alternative to a cathode ray tube (CRT), there have recently been developed various flat panel display apparatuses such as a liquid crystal display (LCD), a plasma display panel (PDP), an organic light emitting diode (OLED), etc.

Among them, an LCD panel of an LCD apparatus cannot emit light by itself, and thus a backlight unit is placed in back of the LCD panel and emits light. Transmission of light emitted from the backlight unit is adjusted depending on an arrangement of liquid crystals, and the LCD panel and the backlight unit are accommodated in such an accommodating member such as a chassis. A light source employed in the backlight unit includes a line light source such as a lamp and a point light source such as a light emitting diode.

In general, a power supply that converts input power and supplies it to the light source is divided into many blocks. As a large-sized display apparatus has been developed, the number of light sources utilized in the backlight unit increases. Correspondingly, the power supply is also increased in number and its configuration becomes more complicated.

### SUMMARY

One or more exemplary embodiments provide a backlight assembly increased in efficiency and slimmed down, and a display apparatus having the same.

One or more exemplary embodiments also provide a backlight assembly with a simple control structure, and a display apparatus having the same.

One or more exemplary embodiments also provide a backlight assembly with fewer elements to reduce production costs, and a display apparatus having the same.

According to an aspect of an exemplary embodiment, there is provided a backlight assembly including: a power converter which includes a transformer and converts a level of input power; a power factor corrector which corrects and outputs a power factor of original power to the power converter; and a light source driver which is connected to a secondary coil of the transformer and includes a first light emitting diode module, a second light emitting diode module, and a current supplying circuit which balances amperage of power supplied to the first light emitting diode module and the second light emitting diode module.

The light source driver may include a plurality of light source drivers, and the backlight assembly may include a balancing transformer to balance amperage supplied to each of the plurality of light source drivers.

The current supplying circuit may include a balancing capacitor to balance amperage.

The light source driver may include a first light source driver and a second light source driver, the balancing transformer may balance amperage supplied to the first and second light source drivers, and both coils of the balancing transformer may be individually positioned on power supplying paths of the first and second light source drivers.

The balancing transformer may include a primary coil individually positioned on power supplying paths of the plurality of light source drivers, and a secondary coil which forms a predetermined closed loop and is opposed to the primary coil.

The light source driver may include a first light source driver, a second light source driver, a third light source driver and a fourth light source driver, and the balancing transformer may include a first balancing transformer which balances amperage supplied to the first and second light source drivers, a second balancing transformer which balances amperage supplied to the third and fourth light source drivers, and a higher-rank balancing transformer which balances a current flowing in the first and second balancing transformers.

The backlight assembly may further include a driving controller which senses a current flowing in the first and second light emitting diode modules, generates a control signal for controlling a sensed current to reach a predetermined reference current, and output the control signal to the power converter.

The driving controller may perform variable frequency control or invariable frequency control.

The power converter may include a switching element to be driven by one of a half-bridge type and a full-bridge type.

According to an aspect of another exemplary embodiment, there is provided a display apparatus including: a liquid crystal panel which displays an image; and a backlight assembly which emits light toward the liquid crystal panel, the backlight assembly including: a power converter which includes a transformer and converts a level of input power; a power factor corrector which corrects and outputs a power factor of original power to the power converter; and a light source driver which is connected to a secondary coil of the transformer and includes a first light emitting diode module and a second light emitting diode module, and a current supplying circuit which balances amperage of power supplied to the first light emitting diode module and the second light emitting diode module.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a control block diagram of a backlight assembly according to an exemplary embodiment;

FIG. 2 is a control block diagram of a backlight assembly according to another exemplary embodiment;

FIG. 3 is a circuit diagram of the backlight assembly of FIG. 2;

FIG. 4 is another circuit diagram of the backlight assembly of FIG. 2;

FIG. 5 is still another circuit diagram of the backlight assembly of FIG. 2; and

FIG. 6 is a control block diagram of a display apparatus including a backlight assembly of FIG. 2 according to an exemplary embodiment.

### DETAILED DESCRIPTION OF EXEMPLARY EMBODIMENTS

Exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts may be omitted for clarity, and like reference numerals refer to like elements throughout.

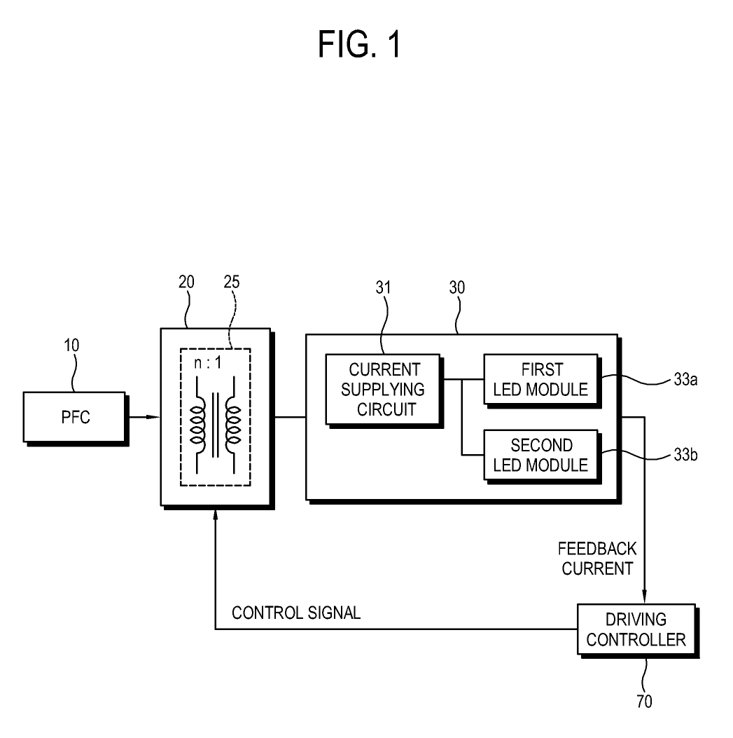

FIG. 1 is a control block diagram of a backlight assembly according to an exemplary embodiment. As shown therein, the backlight assembly includes a power factor corrector (PFC) 10, a power converter 20, a light source driver 30, and a driving controller 70.

The PFC 10 is a power block that converts original power, i.e., input alternating current (AC) power into a direct current (DC) power, and corrects the power factor of the converted DC power. The PFC 10 may include a rectifying circuit for converting the AC power into the DC power. Here, the DC power output from the PFC 10 may have a voltage level between 200 V to 400 V. If a voltage level of original power is less about 75 V, the PFC 10 may be omitted.

The power converter 20 includes an isolation transformer 25. The power converter 20 converts the level of the DC power output from the PFC 10, and outputs it to the light source driver 30. Through the isolation transformer 25, a circuit is protected from high voltage or current generated by a ground loop or a line surge, and a backlight assembly can be stably driven. The power converter 20 may include a non-isolation transformer, instead of the isolation transformer. In this exemplary embodiment, the power converter 20 controls the DC power on the basis of a control signal output through the driving controller 70, which can be achieved by a part of a DC/DC converter including a plurality of switching elements. In a typical DC/DC converter, a capacitor for rectification is connected to an output terminal of the isolation transformer. In this exemplary embodiment, the capacitor for the rectification is included not in the power converter 20 but in a current supplying circuit 31. The power converter 20 may include a circuit driven by various well-known methods such as a half-bridge type, a full-bridge type, etc.

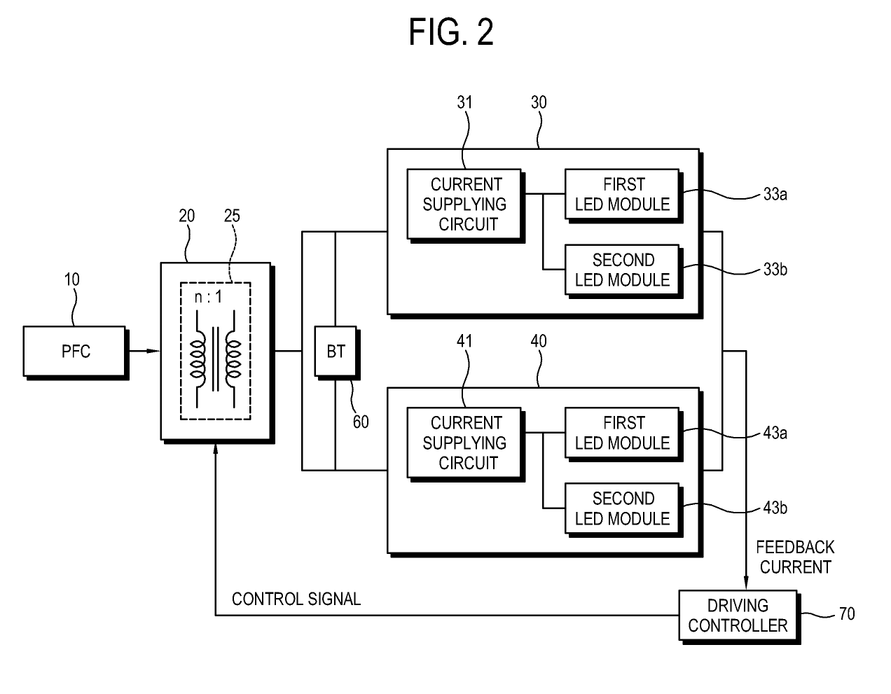

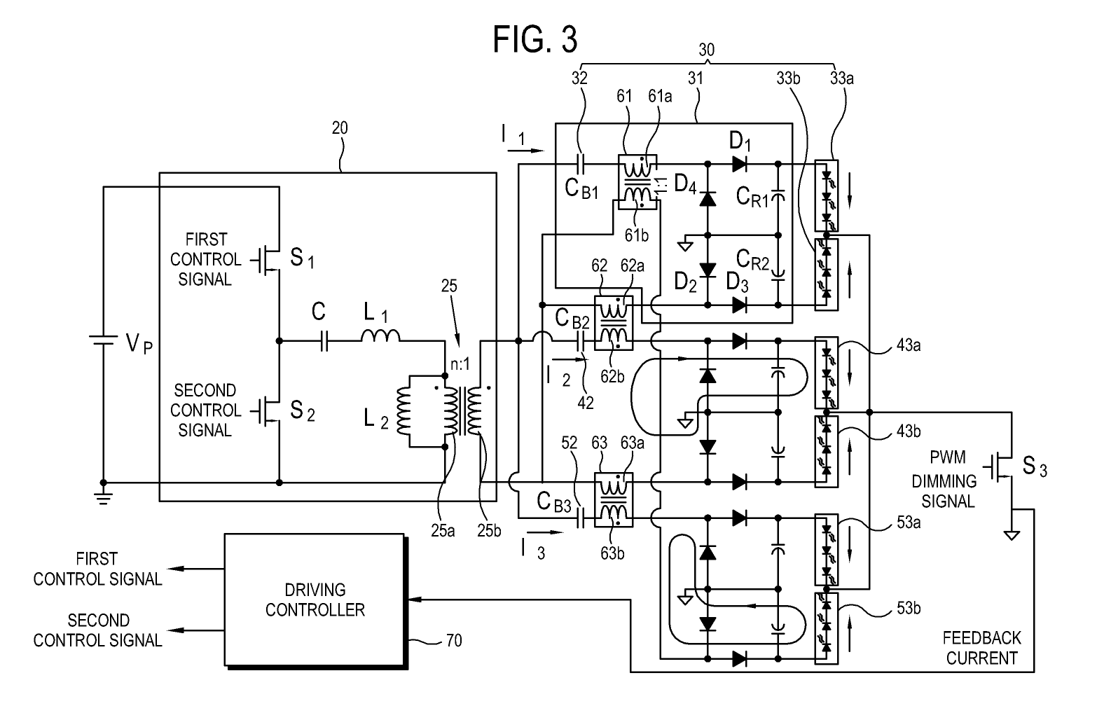

The light source driver 30 is connected to a secondary coil of the isolation transformer 25, and includes a first LED module 33a, a second LED module 33b, and the current supplying circuit 31 which balances amperage of power supplied to the two LED modules 33a and 33b. In this exemplary embodiment, the backlight assembly supplies a current for each of the two LED modules 33a and 33b connected in parallel, and the light source driver 30 balances the current flowing in the two LED modules 33a and 33b equally or to be adjusted according to a preset ratio. To this end, the current supplying circuit 31 includes a balancing capacitor (see FIG. 3) for balancing the amperage, and a plurality of circuit elements (see FIG. 2) for supplying power to the first LED module 33a and the second LED module 33b. The current supplying circuit 31 will be described later in more detail.

The driving controller 70 senses the current flowing in the first LED module 33a and the second LED module 33b, and generates a control signal for controlling the sensed current to reach a predetermined reference current. The generated control signal is applied to the power converter 20, i.e. a switching element included in the power converter 20, and controls the power supplied to the light source driver 30.

In general, a power supply for supplying driving power to a light source unit included in the backlight assembly is divided into many blocks. For example, the power supply includes a block for supplying the DC power from the AC power, a converter block for converting the DC power into a voltage having a certain level, and a light source driver block for supplying a certain-level current to the light source unit by adjusting a certain-level voltage. In other words, in order to supply input power to the light source unit, the input power has to pass through three blocks. While passing through each block, the properties of the power are individually changed. Efficiency decreases whenever passing through one block. Although each block has a power efficiency of 90%, a final efficiency due to the three blocks is about 73%. That is, since 27% or more power is dissipated as heat, there arises a problem of heat generation. Further, as the number of light sources increases, the number of blocks for supplying the power is also increased, thereby adversely affecting on the slimness of the backlight assembly.

In this exemplary embodiment, the power output from the PFC 10 is controlled by only the driving controller 70. The elements included in the current supplying circuit 31 are all passive devices, and do not need separate control. That is, the backlight assembly includes a first block having the PFC 10 and a second block having the converter block and the light source driver block, instead of three power blocks requiring three controls. The circuit used in the control is reduced, so that the control can be simplified, the driving efficiency can be increased, and a production cost can be decreased. Also, heat generation of the backlight assembly is improved, and the backlight assembly can become slimmer as the power blocks are reduced.

FIG. 2 is a control block diagram of a backlight assembly according to another exemplary embodiment of the present invention. As shown therein, the backlight assembly includes a PFC 10, a power converter 20, a plurality of light source drivers 30 and 40, a balancing transformer 60 and a driving controller 70.

The plurality of light source drivers 30 and 40 are connected to a secondary coil of an isolating transformer 25.

The balancing transformer (BT) 60 balances amperage supplied to the light source drivers 30 and 40, and includes a coupled inductor as shown in FIG. 2. The balancing transformer 60 balances currents flowing in the plurality of light source drivers 30 and 40 equally or to be adjusted according to a preset ratio, which can balance the currents without any separate control device. In this exemplary embodiment, the backlight assembly includes a passive device that does not require a separate control, and balances not only the amperages between LED modules 33a and 33b and between the LED modules 44a and 44b but also the amperages supplied to the light source drivers 30 and 40. Likewise, in this case, the backlight assembly includes a first block having the PFC 10, and a second block having a converter block and a light source driver block, so that a circuit cab be simpler and a driving efficiency can be higher than those of related art backlight assemblies having three blocks.

FIG. 3 is a circuit diagram of the backlight assembly of FIG. 2. The backlight assembly of FIG. 3 includes three light source drivers 30, 40 and 50. The PFC 10 (refer to FIG. 2) outputs DC power VP to the power converter 20. The power converter 20 is a half-bridge type circuit including switching elements S1 and S2 and includes a capacitor C, inductors L1 and L2 and the isolation transformer 25. The isolation transformer 25 has a turns ratio between a primary coil 25a and a secondary coil 25b, i.e., a coil ratio of n:1, and the level of the DC power VP is adjusted depending on the coil ratio. The current flowing in each light source driver 30, 40 and 50 through the isolation transformer 25 is from AC power having a sinusoidal waveform.

In this exemplary embodiment, the plurality of light source drivers 30, 40 and 50 are connected in parallel with the secondary coil 25b of the isolation transformer 25. Here, only three light source drivers are shown for convenience of description, but there is no limit to the number of light source drivers as long as it is more than two.

In this embodiment, the light source drivers 30, 40 and 50 are symmetrical circuits each having the same elements. Thus, a first current 11 supplied to a first light source driver 30, a second current 12 supplied to a second light source driver 40 and a third current 13 supplied to a third light source driver 50 are substantially equal to one another.

Referring to the first light source driver 30 among three light source drivers 30, 40 and 50, the currents supplied to the LED modules 33a and 33b are as follows. Here, the first light source driver 30 includes a current supplying circuit 31, a balancing capacitor (CBI) 32, a first LED module 33a, and a second LED module 33b.

Each LED module 33a and 33b includes a plurality of LEDs, but not limited thereto as long as it is a light source to be driven by DC power. The two LED modules 33a and 33b include the same number of LEDs.

The current supplying circuit 31 includes a plurality of diodes D1, D2, D3 and D4 forming a route of a current supplied to the respective LED modules 33a and 33b; rectifying capacitors CR1 and CR2 connected in parallel with the respective LED modules 33a and 33b; and a balancing capacitor 32 which balances the amperages of two LED modules 33a and 33b.

The balancing capacitor 32 filters out a DC component of the first current 11 having a sinusoidal waveform, so that the first current 11 can be maintained in a steady state. Thus, the current flowing in the balancing capacitor 32 for one cycle becomes 0, so that the balancing capacitor 32 can equivalently adjust positive and negative components of the sinusoidal waveform to flow in the first LED module 33a and the second LED module 33b.

The positive component of the first current 11 is supplied to the first LED module 33a via the first diode D1, the first rectifying capacitor CR1 and the second diode D2. When the first LED module 33a emits light, the first diode D1, the first rectifying capacitor CR1 and the second diode D2 form a closed loop together with the secondary coil 25b of the isolation transformer 25 (refer to the closed loop (I) of the second light source driver 40).

Further, the negative component of the first current 11 is supplied to the second LED module 33b via the third diode D3, the second rectifying capacitor CR2 and the fourth diode D4. When the second LED module 33b emits light, the third diode D3, the second rectifying capacitor CR2 and the fourth diode D4 form a closed loop together with the secondary coil 25b of the isolation transformer 25 (refer to the closed loop (11) of the third light source driver 50). Through the first rectifying capacitor CR1 and the second rectifying capacitor and CR2, a DC current having a square waveform is applied to the first and second LED modules 33a and 33b.

Each balancing transformer (BT) 61, 62 or 63 balances the amperages of two light source drivers 30 and 40, 40 and 50 or 50 and 30. In this exemplary embodiment, both coils 61a and 61b, 62a and 62b or 63a and 63b of each balancing transformer 61, 62 or 63 are positioned on power supplying paths of each light source driver 30, 40 or 50, respectively. For example, the primary coil 61a of the first balancing transformer 61 is positioned on the power supplying path of the first light source driver 30, and the secondary coil 61b of the first balancing transformer 61 is positioned on the power supplying path of the third light source driver 50. Each balancing transformer 61, 62 or 63 has a coil ratio of 1:1, so that the amperages supplied to two light source drivers 30 and 40, 40 and 50, or 50 and 30 can be uniformly adjusted.

In short, the currents supplied to the two LED modules 33a and 33b, 43a and 43b or 53a and 53b, each included in the light source driver 30, 40 or 50, are uniformly controlled by the balancing transformers 61, 62 and 63. In this case, the currents supplied to the LED modules 33a, 33b, 43a, 43b, 53a and 53b can be automatically balanced without an additional control circuit, which would have the same effect as omitting a control circuit.

The driving controller 70 receives the currents flowing in the LED modules 33a, 33b, 43a, 43b, 53a and 53b as feedback and generates control signals to control the currents flowing in the LED modules 33a, 33b, 43a, 43b, 53a and 53b to reach preset reference currents. The first control signal and the second control signal output to the switching elements S1 and S2 of the power converter 20. The reference current can be set up or changed by a user. The driving controller 70 may output the control signal under variable frequency control or invariable frequency control, and such control of the driving controller 70 may include various well-known arts.

In this exemplary embodiment, a pulse width modulation (PWM) dimming signal may be applied to the LED modules 33a, 33b, 43a, 43b, 53a and 53b in order to control the brightness of the light emitted from the LED modules 33a, 33b, 43a, 43b, 53a and 53b. Here, a third switching element S3 may be turned on/off to control the current flowing in the LED modules 33a, 33b, 43a, 43b, 53a and 53b.

According to another exemplary embodiment there may be only two balancing transformers with respect to three light source drivers 30, 40 and 50. For example, only the first and second light source drivers 30 and 40 and the second and third light source drivers 40 and 50 may include the balancing transformers. In this case, the amperages supplied to the first light source driver 30 and the second light source driver 40 are balanced, and the amperages supplied to the second light source driver 40 and third light source driver 50 are balanced, thereby resulting in balancing the amperages supplied to the first and third light source drivers 30 and 50.

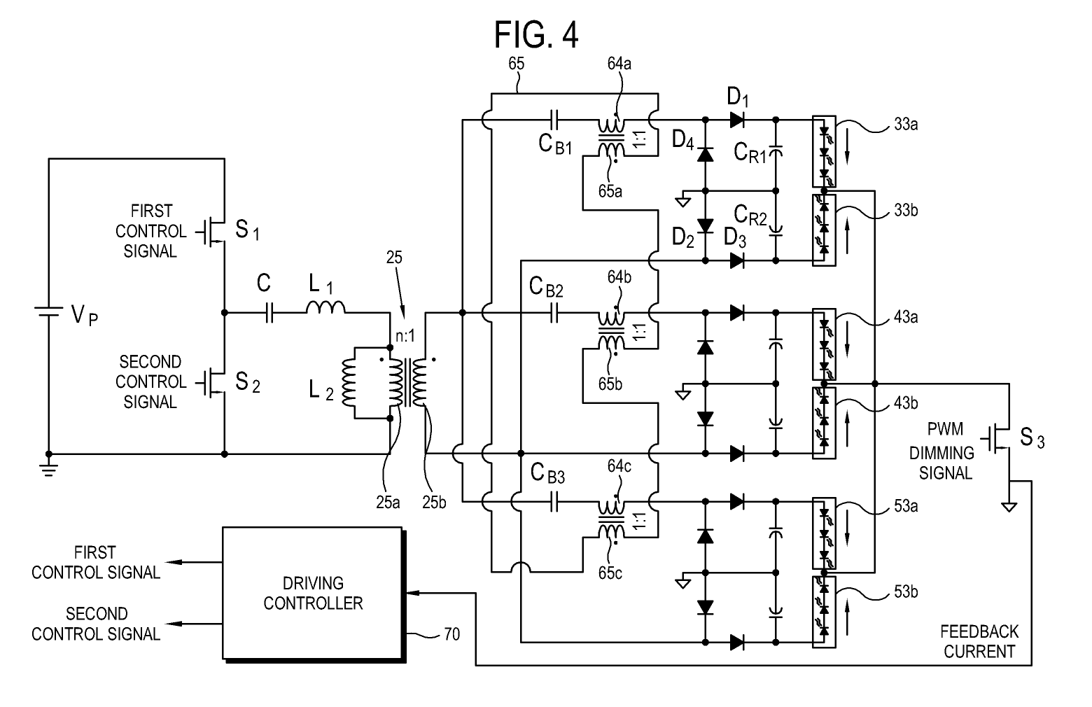

FIG. 4 is another exemplary circuit diagram of the backlight assembly of FIG. 2. The backlight assembly shown in FIG. 4 has the same confirmation as that of FIG. 3 except for the balancing transformer, and thus repetitive descriptions thereof will be avoided as necessary.

As shown therein, the balancing transformer in this exemplary embodiment includes primary coils 64a, 64b and 64c individually positioned on power supplying paths of the light source drivers 30, 40 and 50, and secondary coils 65a, 65b and 65c opposite to the primary coils 64a, 64b and 64c forming a predetermined closed loop 65. Since the secondary coils 65a, 65b and 65c form the closed loop, the currents flowing in the respective secondary coils 65a, 65b and 65c are the same. Further, because a coil ratio between the primary coil 64a, 64b or 64c and the secondary coil 65a, 65b and 65c is 1:1, the current flowing in the primary coil 64a, 64b or 64c is equal to that flowing in the secondary coil 65a, 65b or 65c. Thus, the same amperage is applied to each light source driver 30, 40 or 50.

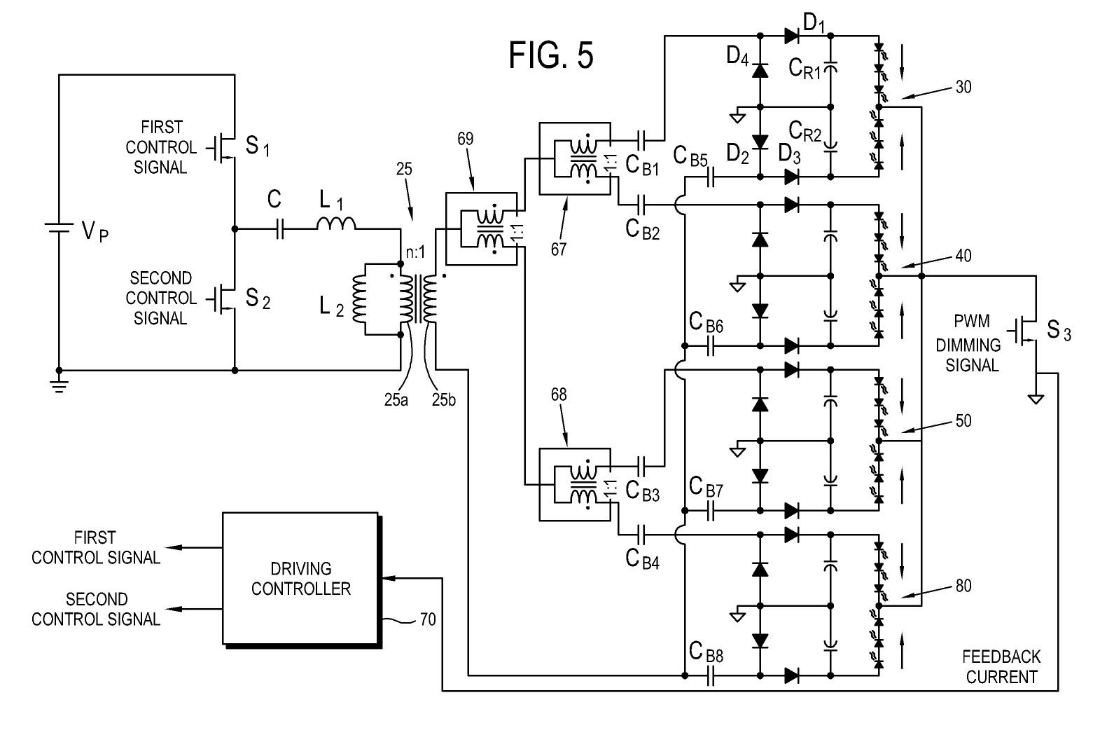

FIG. 5 is still another exemplary circuit diagram of the backlight assembly.

In this embodiment, the backlight assembly includes a fourth light source driver 80 and a higher-rank balancing transformer 69 for balancing the currents flowing in a balancing transformer 67 and a balancing transformer 68.

The fourth balancing transformer 67 is provided between the first light source driver 30 and the second light source driver 40 to balance the amperages, and likewise the fifth balancing transformer 68 is provided between the third light source driver 50 and the fourth light driver 80 to balance the amperages.

The higher-rank balancing transformer 69 controls the amperage to be uniformly supplied to the fourth balancing transformer 67 and the fifth balancing transformer 68, so that the current flowing in each of the first to fourth light source drivers 30 to 80 can be uniform.

Also, in this exemplary embodiment, the light source drivers 30, 40, 50 and 80 include two balancing capacitors CB1 and CBS, CB2 and CB6, CB3 and CB7, and CB4 and CB8, respectively. The additional balancing capacitors CBS, CB6, CB7 and CB8 are positioned on a lower side of the secondary coil 25b of the isolation transformer 25, and balance the amperage and stabilize the power together with the existing balancing capacitors CB1, CB2, CB3 and CB4. Such additional balancing capacitors CBS, CB6, CB7 and CB8 may be applied to the backlight assemblies of the foregoing embodiments, and whether to add or omit the balancing capacitors CB5, CB6, CB7 and CB8 may be done according to a user's selection.

Alternatively, the secondary coil of the isolation transformer may be provided in each of the light source drivers 30, 40, 50 and 80. That is, a plurality of secondary coils of the isolation transformer 25 may be provided parallel with respect to the primary coil, and the light source driver may be connected to each secondary coil.

Further, the balancing transformers 61, 62, 63, 67 and 68 may have coil ratios other than 1:1. By adjusting the coil ratio of the balancing transformer, the amperage supplied to the light source driver can be controlled. For example, if the coil ratio is n:1, the amperage supplied to large coil turns is less than that supplied to small coil turns.

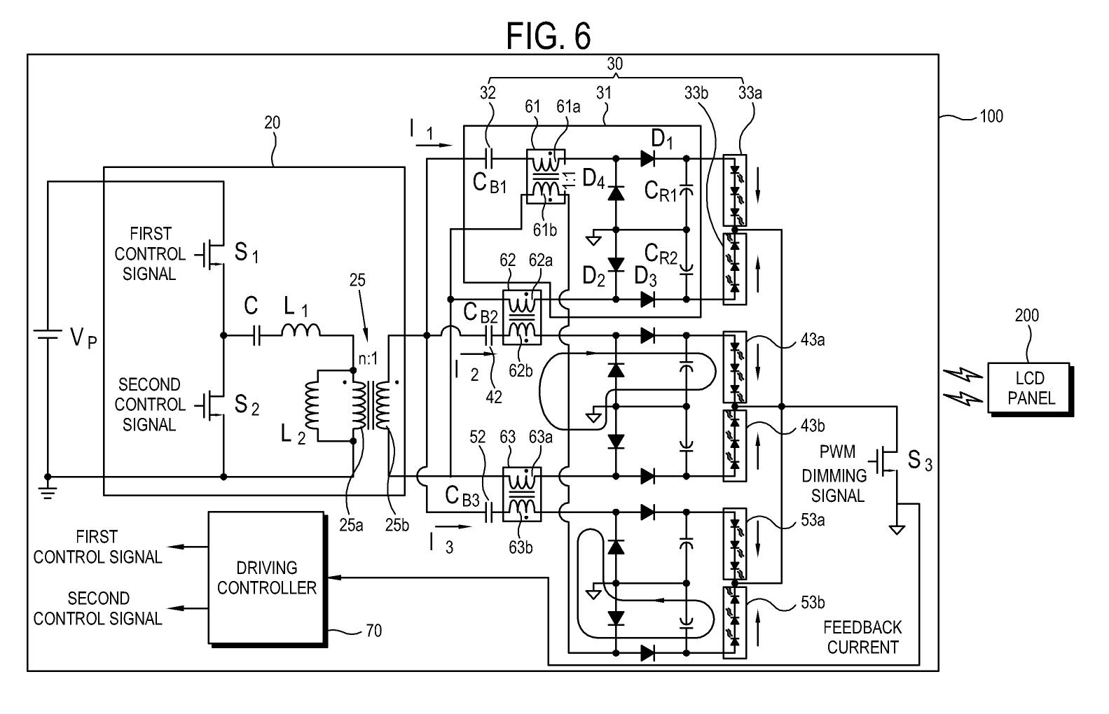

FIG. 6 is a control block diagram of a display apparatus including a backlight assembly of FIG. 2. The display apparatus includes the backlight assembly 100 as shown in FIG. 3 and an LCD panel 200. Besides, the display apparatus may include one of the backlight assemblies shown in FIGS. 4 and 5 and the backlight assemblies according to the foregoing exemplary embodiments.

The backlight assembly 100 is placed in back of the LCD panel 200 and emits light toward the LCD panel 200. Here, scanning may be achieved by applying the PWM control signal to each of the LED modules of the backlight assembly 100, or local dimming may be achieved by applying the locally dimming signal to the LED modules to correspond to a certain area of the LCD panel 200. That is, the brightness can be controlled in consideration of a video signal displayed on the LCD panel 200.

The backlight assembly 100 in this exemplary embodiment has hardware and control structures simpler than those of the ones in the related art, thereby contributing to the slimness of a thinner display apparatus.

As described above, there are provided a backlight assembly increased in efficiency and slimmed down, and a display apparatus having the same.

Further, there are provided a backlight assembly with a simple control structure, and a display apparatus having the same.

Also, there are provided a backlight assembly with fewer elements to reduce production costs, and a display apparatus having the same.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A backlight assembly comprising:
a power converter which converts a level of input power, wherein power converter comprises a transformer;
a power factor corrector which corrects a power factor of original power and outputs the corrected power factor to the power converter; and
a light source driver which is connected to a secondary coil of the transformer, wherein the light source driver comprises a first light emitting diode module, a second light emitting diode module, and a current supplying circuit which balances amperage of power supplied to the first light emitting diode module and the second light emitting diode module.

2. The backlight assembly according to claim 1, wherein the light source driver comprises a plurality of light source drivers, and
the backlight assembly further comprising a balancing transformer to balance amperage supplied to each of the plurality of light source drivers.

3. The backlight assembly according to claim 1, wherein the current supplying circuit comprises a balancing capacitor to balance the amperage of power supplied to the first light emitting diode module and the second light emitting diode module.

4. The backlight assembly according to claim 2, wherein the light source driver comprises a first light source driver and a second light source driver,
the balancing transformer balances the amperage supplied to the first light source driver and the second light source driver, and
a primary coil and a secondary coil of the balancing transformer are individually positioned on power supplying paths of the first light source driver and the second light source driver, respectively.

5. The backlight assembly according to claim 2, wherein the balancing transformer comprises a plurality of primary coils, each individually positioned on one power supplying path of the plurality of light source drivers, and a plurality of secondary coils, each corresponding to one of the plurality of primary coils, and each of the plurality of secondary coils opposes the corresponding primary coil forming a predetermined closed loop.

6. The backlight assembly according to claim 2, wherein the light source driver comprises a first light source driver, a second light source driver, a third light source driver and a fourth light source driver, and the balancing transformer comprises a first balancing transformer which balances an amperage supplied to the first light source driver and the second light source driver, a second balancing transformer which balances an amperage supplied to the third light source driver and the fourth light source driver, and a higher-rank balancing transformer which balances a current flowing in the first balancing transformer and the second balancing transformer from the power converter.

7. The backlight assembly according to claim 1, further comprising a driving controller which senses a current flowing in the first light emitting diode module and a current flowing in the second light emitting diode module, generates a control signal for controlling the sensed currents to reach predetermined reference currents, and outputs the control signal to the power converter.

8. The backlight assembly according to claim 7, wherein the driving controller performs one of variable frequency control and invariable frequency control.

9. The backlight assembly according to claim 1, wherein the power converter comprises a switching element to be driven by one of a half-bridge type and a full-bridge type.

10. The backlight assembly according to claim 2, wherein the plurality of light source drivers are uniformly controlled by a plurality of balancing transformers, each of the plurality of balancing transformers comprises a primary coil and a secondary coil, and the primary coil and the secondary coil of each balancing transformer are individually positioned on power supplying paths of one of the plurality of light source drivers and a different one of the plurality of light source drivers, respectively.

11. The backlight assembly according to claim 7, wherein the power converter comprises a first switching element and a second switching element which receive a first control signal and a second control signal from the driving controller, respectively, for controlling the sensed currents to reach the predetermined reference current.

12. A display apparatus comprising:
a liquid crystal panel which displays an image; and
a backlight assembly which emits light toward the liquid crystal panel,
the backlight assembly comprising:
a power converter which converts a level of input power, wherein the power converter comprises a transformer;
a power factor corrector which corrects a power factor of original power and outputs the corrected power factor to the power converter; and
a light source driver which is connected to a secondary coil of the transformer, wherein the light source driver comprises a first light emitting diode module, a second light emitting diode module, and a current supplying circuit which balances amperage of power supplied to the first light emitting diode module and the second light emitting diode module.

13. The display apparatus according to claim 12, wherein the light source driver comprises a plurality of light source drivers, and
the display apparatus assembly further comprising a balancing transformer to balance amperage supplied to each of the plurality of light source drivers.

14. The display apparatus according to claim 12, wherein the current supplying circuit comprises a balancing capacitor to balance the amperage of power supplied to the first light emitting diode module and the second light emitting diode module.

15. The display apparatus according to claim 13, wherein the light source driver comprises a first light source driver and a second light source driver,
the balancing transformer balances amperage supplied to the first light source driver and the second light source driver, and
a primary coil and a secondary coil of the balancing transformer are individually positioned on power supplying paths of the first light source driver and the second light source driver, respectively.

16. The display apparatus according to claim 12, wherein the backlight assembly further comprises a driving controller which senses a current flowing in the first light emitting diode module and a current flowing in the second light emitting diode module, generates a control signal for controlling the sensed currents to reach predetermined reference currents, and outputs the control signal to the power converter.

17. The display apparatus according to claim 13, wherein the plurality of light source drivers are uniformly controlled by a plurality of balancing transformers, each of the plurality of balancing transformers comprises a primary coil and a secondary coil, and the primary coil and the secondary coil of each balancing transformer are individually positioned on power supplying paths of one of the plurality of light source drivers and a different one of the plurality of light source drivers, respectively.

18. The display apparatus according to claim 16, wherein the power converter comprises a first switching element and a second switching element which receive a first control signal and a second control signal from the driving controller, respectively, for controlling the sensed currents to reach the predetermined reference current.

19. A backlight assembly comprising:
a power converter which converts a level of input power, wherein the power converter comprises a transformer;
a power factor corrector which corrects a power factor of original power and outputs the corrected power factor to the power converter;
a plurality of light source drivers, each connected to a secondary coil of the transformer; and
a balancing transformer which balances amperage supplied to each of the plurality of light source drivers.

20. The backlight assembly according to claim 19, wherein each of the plurality of light source drivers comprises:
a first light emitting diode module;
a second light emitting diode module; and
a current supplying circuit which receives the amperage supplied from the balancing transformer and balances amperages of power supplied to the first light emitting diode module and the second light emitting diode module.
